(19) United States
(12) Patent Application Publication
(10) Pub. No.: US 2016/0366589 A1
(43) Pub. Date: Dec. 15, 2016

(54) Remote access confirmation and/or authentication and/or authorization service used for confirmation of access identity, device ownership, and meetings using mobile devices for a system or an individual

(71) Applicant: Jerry Jean, Le Gardeur (CA)

(72) Inventor: Jerry Jean, Le Gardeur (CA)

(21) Appl. No.: 15/177,625

(22) Filed: Jun. 9, 2016

(30) Foreign Application Priority Data
Jun. 9, 2015 (GB) 1510042.3

(51) Int. Cl. H04W 12/06; H04W 4/14; H04L 29/06

(52) U.S. Cl. CPC H04W 12/06; H04L 63/083; H04L 63/0861; H04W 4/14

(57) ABSTRACT

A remote confirmation and/or authentication and/or authorization service used for confirmation of access identity, device ownership, and meetings using mobile devices for a system or an individual.

### FIELD OF THE INVENTION

The present invention relates generally to IT, Internet and mobile devices, but more particularly to a remote confirmation and authentication service for validating access request, identity, mobile device ownership, meetings and appointments. The main purpose of this invention is the secure authentication process when accessing a remote system. Remote authentication dial-in user service (RADIUS) is a known standard and this art offers new and unobvious features in the authentication process over the prior art.

### BACKGROUND OF THE INVENTION

When accessing a remote application inside a private network over the

Internet, it is essential that a secure access control validates the identity and the right of the user to gain such access. This process, referred as the authentication process, where a user has to prove his identity in order to be provided with the proper access rights, is based on three basic guiding principles. These principles are something you know such as the combination of a unique identifier and a secret code, who you are, which is based on a unique biometric feature, and something you possess such as a telephone or smart card.

a) Something you know (the combination of a unique identifier and a secret code).

b) Something you have (phone, pager, card, key, mobile devices).

c) Who you are (biometric feature).

Each of these principles are called authentication factors. It is known that the more factors used, the stronger the authentication process is, and the security level it provides. The prior art is using a security standard authentication protocol called REMOTE ACCESS DIAL IN USER (RADIUS). Here are some shortcomings of the prior art, such as the limitation to have user information reside in a central data storage location. Also prior art using RADIUS do not offer the possibility to have an external agent approve the access in real time. Approval of access is linked to the validity of the authentication factors, and not the actual approval of the access itself at an unknown future given time and date.

### SUMMARY OF THE INVENTION

In view of the foregoing disadvantages inherent in the known devices now present in the prior art, the present invention, which will be described subsequently in greater detail, is to provide objects and advantages which are:

To provide for a process that requires the use of an automated communication process with a remote user to prompt or challenge and capture responses in order to apply a procedural logic for analysis and actions.

It is another advantage to use the biometric feature capture capabilities of the mobile device in the remote confirmation and/or authentication. Unlike prior art that use iris, face and fingers, this art uses new biometric features such as heart rate and heat signatures.

This application uses the term “EZ” in combination with other terms to describe certain functions. This terminology was created as it may also be used as trademarked terms for commercial purposes. Here, these terms are used for simplification and clarity.

Patent U.S. Pat. No. 7,870,599 uses voice and phone calls to what is commonly referred to as out of band authentication. This application introduces

SMS replies as an alternative in the process to be considered an equivalent out of band authentication the same as a code entered over the phone or on a keypad.

Instead of focusing on the generation of a secret code called One Time Password (OTP), such as U.S. Pat. No. 7,249,177, this application focuses on the process and not the way the OTP is generated or the algorithm applied to validate the code entered by mediums defined in prior arts.

In prior art conventional systems that perform remote access identification take charge of the whole verification process. This application allows for separation of the process in terms of:

Decentralizing all attributes over a plurality of locations which are either stored on a structured database or in a Lightweight Directory Access Protocol system (LDAP). In this application, the novel approach is to modify the process so that flexibility is given to allow the selection of the repository for every single attribute required in the remote access authentication process. The attributes can be stored in a file, in an external data, such as a database, or in an LDAP server that can be different from the LDAP server hosting the user's primary credentials (Main user name and password). This acknowledges the distinctiveness of the nature of each attributes such that security information and human resource information do not reside inside the same structures. In prior art, failure to recognize this distinction forced organizations to put in place new processes and structures to combine all the security information and human resource information in a single location which required long term costly maintenance. The primary security account information, and the employee personal HR file (employee ID, email and cell phone) are stored in different repositories than his computer access username and password.

Many patents related to authentication assume the whole process where they perform the first authentication and then proceed to a second authentication. This solution not only separates the process and isolates the registration as a user based service, it does not care whether there is a first or second factor of authentication. It simply executes a task and at the minimum, confirms the user's possession of a device but not restricted to this function only. The solution comprises 3 distinct processes:

User registration.

Device verification requests.

Challenge process/Confirmation.

User registration: Conventionally, users register to the service where they will require access. Then all the user's attributes are stored for future use such as for authentication. Attributes can be anything that is part of the user's profile namely alias, and phone numbers. In this solution, registration is done simply by the user, independently from the systems/applications/networks he wants to access, he self-registers providing a list of aliases/destination combinations.

The first time, the user receives an SMS to confirm its ownership of the device, process which couples the device to his member profile in our database. The user can download an application that acts as a security/communication broker between the device/applications with the solution (mainly for biometric verification).

Requester registration: Systems that want to use the service go through a registration where a secret key is exchanged to identify and secure device verification requests. All subsequent requests require users to provide the access key provided at registration.

Device verification requests: Basically the solution receives a request for verification/confirmation through an API/web service or RADIUS over a secure communication channel. The solution offers any of the supported methods which are:

1 An SMS message with a supplied message by the requesting application server.

2 An SMS message to the user requiring an SMS reply with the one time password or predefined code (secret) received.

3 A clickable Web encrypted link trough an SMS message.

4 A phone call with single or multiple key pressed.

5 A biometric signature (heat signature, heart rate signature, body silhouette) on a remote device.

6 A prompt to confirm access request on the user's mobile device (requires installation of an application).

Confirmation: The solution, through the internet/voip/cellular network, exchanges information with the user's device and returns to the requester whether the process was successful or failed.

Procedural Innovations: In the security industry RADIUS is the main authentication validation protocol used. Conventionally, systems using

RADIUS do not allow flexibility in the configuration of the different factors to be used, the location of the attributes of the users required to perform authentication and these systems never act as a simple transport requiring the handling of the whole validation process. In this context searching for required attributes from different location, being able to handle all or part of the validation process, processing the user's request without having the knowledge of the OTP generated and accepting SMS replies are all differentiating factors of this art. Furthermore, adding the capability of using Radius to add a real time authorization/approval as a third factor is innovative and will protect critical system from unwanted changes or access. Authorization and

Authentication are distinctive processes as Authorization controls your real time access and not your identity or your preconfigured permissions.

The system allows the configuration specifying the location information for each of these attributes. At the time of receiving an access request, the system gathers the information based on the configuration and uses it to send a challenge to the user that can be in the form of a one time password, a predefined password or a predefined action.

1—The system can handle the whole validation process consisting of capturing all inputs from the user that consist of one or a combination of factors being categorized as something you know, who you are and something you have (which can be virtual like having a phone number accessed through an application) and perform the validation through a procedural logic and defined algorithm, and send back the result of such algorithm as an accept or a deny.

2—The system can validate part of the verification process and, for example, validate only one of the three factors being something you have. It can perform the validation using a logic and defined algorithm for that single factor and send back the result of such algorithm as being accept, deny or simply passing back the action performed by the access requester.

3—The system can act as a simple transport mechanism and challenge the user to provide an information and pass that information back to the validation server that is not part of this present invention. In this scenario the system does not have prior knowledge of the secret and does not perform match validation and lets the application/website outside of this art decide whether it allows the access based on its own logic.

4—The system introduces a new process called supervisor authorization or the 3^{rd} factor where the system sends the request for access to an external agent (a human or any external authorization device), holding the request pending in real time, that will decide whether the user can continue with the process to receive the challenge and gain the access requested. Prior art offers approval in a deferred method where all requests are sent to a system pending approval whereas this instant invention uses real time technologies (Phone call, SMS reply) to get the required approval. In this scenario one example consists of the user being first validated using a first factor and if successful a request for access is sent to an external agent and only if that agent sends an approval, that the access requester can proceed to the next validation step comprised of one or more of something you have or who you are for example. The whole process taking place within the time frame of the access request.

5—The system also introduces SMS replies as a mechanism for proving the possession of a device (physical or virtual) or used as one of the factors in the process. Conventionally the SMS was used to received a one time password (OTP) and users had to input the OTP secret back to the first channel where the access request originated. In the past year there have been security breaches where such OTP would be intercepted without the user's knowledge. In this invention the SMS reply can not be impersonated since it will require the user to actually send a reply from the device and the device ID (like a telephone number) will be part of the validation.

6—This instant invention allows for a default secret that can be used by all the users within a security domain, which means that in this implementation of the system the device itself becomes the validation factor without the necessity for an OTP.

7—In case of emergencies and the inability for a user to prove his identity, the system allows for a break glass mechanism where access is provided by the retrieval of a one time secret through methods such as a phone call, an SMS or a web link. A process for tracking the use of the break glass and send automated alerts will support this process.

8—This instant invention introduces the use of heart rate and heat signatures as being one of the biometric features used for proving identity. These biometric features can be captured using new technologies that are worn on the user's body. (Watch, glasses, bracelet).

This process is easy to use both for the attendant users and for service providers (websites, networks etc . . . ) eliminating the need for additional development or extensive technical knowledge. The solution does not act strictly as a multiple factor authentication system but can act as a simple device verification system or confirmation tools such as meeting confirmation.

No username password combination exists but instead the option to store username to cell numbers and/or device unique ID. At the minimum the solution acts as a service broker like a RADIUS agent where it will execute a request to communicate to a mobile device. At most it will handle all the verification/confirmation and will return results of success or failure.

The fact that the users can self-register either by going on the solution's provided portal or simply by texting this service is another innovative way for users to quickly get registered. A simple text including a list of aliases and remote sites will automatically register the user.

Additionally, on a first attempt of a valid user to gain remote access, the instant invention recognizes the absence of a required attribute for the second factor challenge, say a telephone number or a Google Authenticator secret, and automates a self enrollment with the said user through SMS or email and saves the response from the user in the appropriate location. This relieves the burden on the organization to deploy and maintain enrollment portals and processes.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiment and of being practiced and carried out in various ways. Also, it is to be understood that the phraseology and terminology employed herein are for the purpose of description and should not be regarded as limiting

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiment of the invention.

### BRIEF DESCRIPTION OF THE DRAWINGS

FIG. 1 Embodiment 1 cloud service with no local agent.

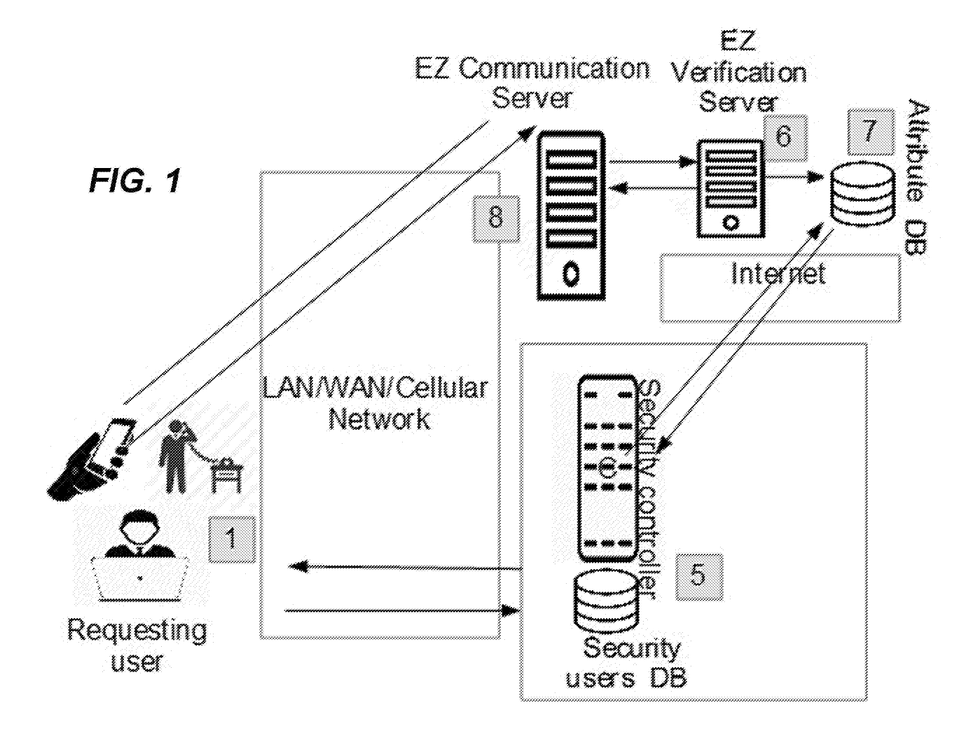

FIG. 2 Embodiment 2 second factor with local agent.

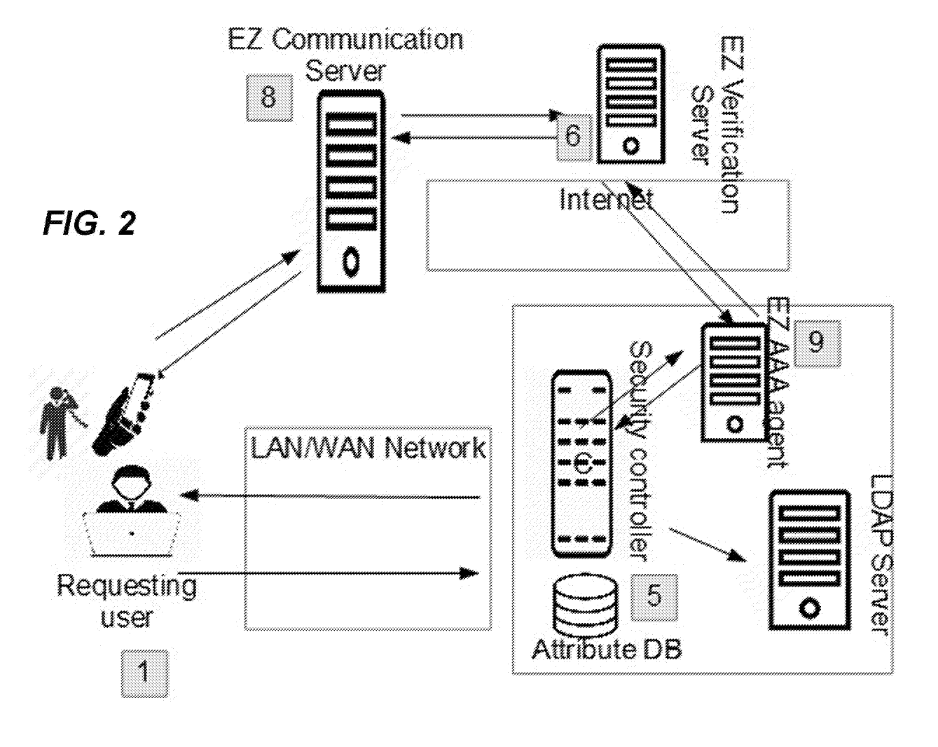

FIG. 3 Embodiment 3 with local agent and supervisor authorization.

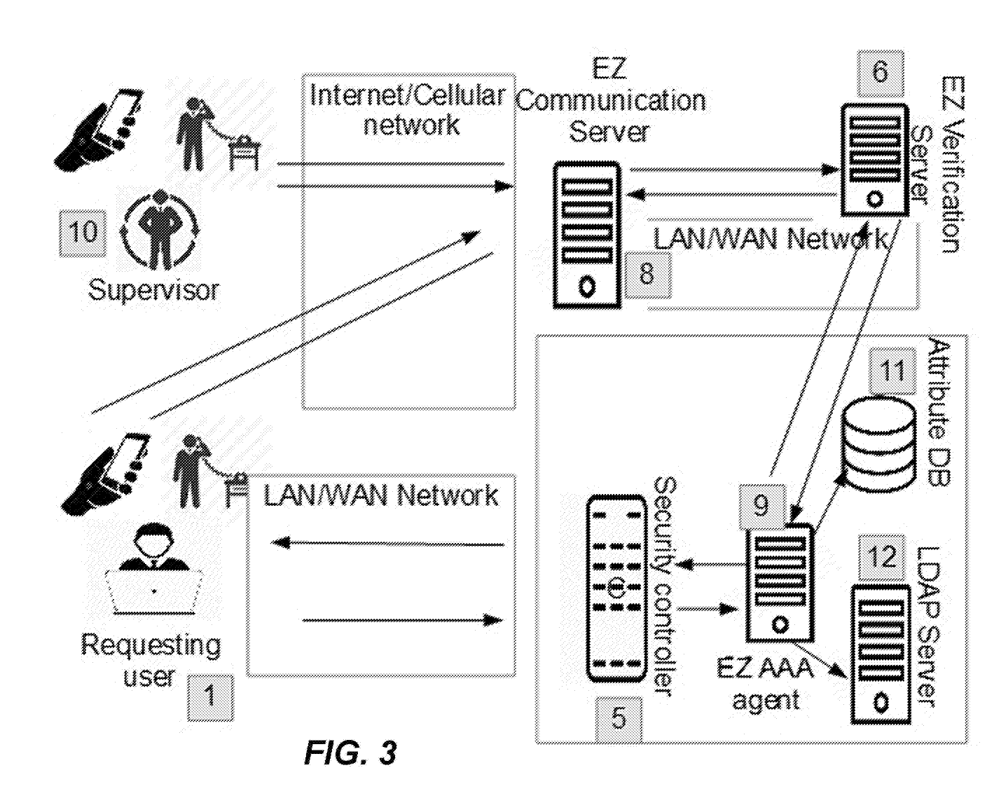

### DETAILED DESCRIPTION OF THE PREFERRED EMBODIMENT

Problematic: There are patents for remote authentication using PSTN (public switched telephone networks) but in our case we use VOIP (voice over ip) and web services/API which are not protected under other patents. Other patents are strictly aimed towards the verification of the user's identity and the methodology of OTP generation. This instant invention offers to reduce the level of complexity in the process and provide more flexibility in terms of configuration and in some cases simply execute message transfer and response requests.

In one implementation of this solution no usernames or password are necessary. A simple call to the web service/API/RADIUS agent to send a message by SMS, phone call or bio-metric signature, will achieve the goal. Again, unlike the prior art, the RADIUS agent can simply return the captured input from the user without performing the actual validation. This is the simplicity by which this instant invention distinguishes itself.

Definitions: User, Registration server (2), EZ-MOBILE AGENT (22), Mobile device (4), Requester (5), EZ-VERIFICATION server (6), EZ-DB User database (7), EZ-COMMUNICATION server (8), EZ-VERIFICATION agent (9).

User registration embodiment 1.

1 User (1) registers on registration server (2).

2 User (1) enters device cell number.

3 The EZ-registration server (2) sends a PIN and cell number to the EZ-COMMUNICATION server (8).

4 The EZ-COMMUNICATION server (8) sends the PIN to the user's mobile device (4) by SMS.

5 User (1) enters code received on registration server (3).

6 Registration server confirms registration.

User registration embodiment 2.

1 User downloads EZ-MOBILE AGENT (22) from registration server (3) or any approved repository.

2 User (1) enters device cell number in the EZ-MOBILE AGENT (22).

3 EZ-MOBILE AGENT (22) sends the cell number to the EZ-registration server (2).

4 The EZ-registration server (2) sends the PIN and cell number to the EZ-COMMUNICATION server (8).

5 The EZ-COMMUNICATION server (8) sends the PIN to the user's mobile device (4) by SMS.

6 User (1) enters code received on the EZ-MOBILE AGENT (22).

7 The EZ-MOBILE AGENT (22) creates a secret key using the SMS entered and other information specific to the user's mobile device (4).

8 The EZ-MOBILE AGENT (22) sends the new secret key to EZ-registration server (2).

9 The EZ-registration server (2) decrypts the received message and validates the PIN.

10 The EZ-registration server (2) stores the device specific information and associates the user's cell number and EZ-MOBILE AGENT (22) Unique ID and sends registration confirmation to the EZ-MOBILE AGENT(22) installed on the user's mobile device (4).

User registration embodiment 3.

1 User (1) sends SMS to EZ-registration server (2) with list of usernames/aliases with remote systems.

2 The EZ-registration server (2) stores the information and associates the user's cell number.

3 The EZ-registration server (2) sends the confirmation message and cell number to the EZ-COMMUNICATION server (8).

4 The EZ-COMMUNICATION server (8) sends the registration confirmation by SMS to the user's mobile device (4).

Device verification request (cloud service with no local agent) embodiment 1.

1 User (1) makes request to Requester (5).

2 Requester (5) validates user (1).

3 Requester (5) sends a web service request for device verification to an EZ-VERIFICATION server (6) with the user's attributes and methodology to use.

a) If an identifier is an alias or medium is biometric, EZ-VERIFICATION server (6) checks for a match in an EZ-DB User database (7) for a Unique ID of an installed agent (3) on the user's mobile device (4) or cell number.

4—A Challenge process is initiated.

5. A result is comprised of accept, deny, action or code to be sent back to the Requester (5).

Device verification/Confirmation with a local agent embodiment 2.

1 User (1) makes request to Requester (5).

2 Requester (5) performs a first factor validation.

3 Requester (5) sends a username to an EZ-VERIFICATION agent (9) using RADIUS to the EZ-VERIFICATION server (6) or using web service/API.

4 The EZ-VERIFICATION agent (9) or the Requester (5) queries a corporate user information repository/database for an associated user attributes comprised of (phone number, email, third party attribute like google authorization).

5 The EZ-VERIFICATION agent (9) or the Requester (5) sends a web service request for device verification to EZ-VERIFICATION server (6).

6 The challenge process is initiated.

Device verification requiring supervisor authorization embodiment 3.

User (1) makes request for access to the Requester (5) and Requester initiates a RADIUS request to the EZ-VERIFICATION agent (9).

a) If requested by the Requester (5), the EZ-VERIFICATION agent (9) performs the first factor validation by sending the identification information comprised of user's (1) username and password to the security server.

b) If the first factor is not requested, The EZ-VERIFICATION agent (9) verifies if an external party approval is required.

If an external party approval is required, the EZ-VERIFICATION agent (9) performs a search in the predefined repository (11,12) of the required attribute (comprised of LDAP, ODBC, DATABASE or any other structured repository) and sends the attribute value in a request to the EZ-VERIFICATION server (6) for a challenge (see the challenge process).

If the external party approval (10) challenge process resulted in an approval or if the third party approval was not required, the EZ-VERIFICATION agent (9) performs a search in the predefined repository (11,12) (comprised of LDAP, ODBC, DATABASE or any other structured repository) for the user's attributes comprised of cell phone, email ,telephone number or mobile application id like Google authorization).

The EZ-VERIFICATION agent (9) sends the attribute's value in a request comprised of the challenge type (message or action) and the medium to be used to the EZ-VERIFICATION server (6) which then initiates the challenge process.

Challenge process:

1 The EZ-VERIFICATION server (6) receive a request for challenge with informations comprised of the technology to be used, the attribute information, the message and the response type expected (Result from validation or secret captured).

2 The EZ-VERIFICATION server (6) sends the request to the EZ-COMMUNICATION server (8).

3 The EZ-COMMUNICATION server (8) sends message to the user based on the attribute information received that can be any of a mobile application, a mobile computing device or email.

a) If the medium is a phone call, EZ-COMMUNICATION server (8) calls the user's voice capable device (4) and prompts user with a message and captures the predefined key or unique secret pressed by the user (1).

b) If the medium is an encrypted WEBLINK SMS, the request is sent to the user's (1) SMS capable device (4, 6).

c) If the medium is reply SMS, EZ-COMMUNICATION server (8) sends a code to the user's SMS capable device (4) and asks the user (1) to reply using the same code.

d) If the medium is biometric, the request is sent to the installed agent (3) which will capture the user's heart rate and/or heat signature.

e) if the medium is an application, the request is sent using the application's communication predefined method.

The EZ-COMMUNICATION server (8) returns any information captured to the EZ-VERIFICATION server (6).

The EZ-VERIFICATION server (6) processes necessary validation and sends the response comprised of transaction completed, the received message or the accept or reject to the EZ-VERIFICATION agent (9) or the Requester (5).

EZ-VERIFICATION agent (9) evaluates the result received and sends the response to the Requester (5).

1. A remote confirmation and/or authentication service and/or authorization service used for confirmation of access identity, device ownership, and meetings using mobile devices for a system or an individual comprising the use of centralized or a decentralized attributes residing in at least one location; a flexible process to allow for a selection of a repository for every single attribute required in a remote access authentication process.

2. The remote confirmation and/or authentication service and/or authorization service of claim 1 wherein said attributes are being stored in a file in an external data storage.

3. The remote confirmation and/or authentication service and/or authorization service of claim 2 wherein external storage being database.

4. The remote confirmation and/or authentication service and/or authorization service of claim 2 wherein external storage being an LDAP server.

5. The remote confirmation and/or authentication service and/or authorization service of claim 4 wherein said LDAP server is other than an LDAP server hosting said user's primary credentials.

6. The remote confirmation and/or authentication service and/or authorization service of claim 1 wherein said plurality of locations are comprised of, but not limited to storage on a structured database, in a Lightweight Directory Access Protocol system (LDAP).

7. The remote confirmation and/or authentication service and/or authorization service of claim 1 wherein In one implementation of this solution no usernames or password are necessary. A simple call to the web service/API/RADIUS agent to send a message by SMS, phone call or bio-metric signature, will achieve the goal. Again, unlike the prior art, the RADIUS agent can simply return the captured input from the user without performing the actual validation. This is the simplicity by which this instant invention distinguishes itself.

8. The remote confirmation and/or authentication service and/or authorization service of claim 1 comprised of the following steps:
a) said user registers on registration server;
b) said user enters device cell number;
c) said EZ-registration server sends a PIN and cell number to said EZ-COMMUNICATION server;
d) said EZ-COMMUNICATION server sends said PIN to said user's mobile device by SMS;
e) user enters code received on registration server;
f) registration server confirms registration.

9. The remote confirmation and/or authentication service and/or authorization service and/or authorization service of claim 1 wherein, in a second embodiment, user registration is comprised of the following steps:
a) said user downloads EZ-MOBILE AGENT from an approved repository such as, but not limited to a registration server;
b) said user enters device cell number in said EZ-MOBILE AGENT;
c) said EZ-MOBILE AGENT sends cell number to said EZ-registration server;
d) said EZ-registration server sends said PIN and said cell number to said EZ-COMMUNICATION server;
e) said EZ-COMMUNICATION server sends said PIN to said user's mobile device by SMS;
f) said user enters code received on said EZ-MOBILE AGENT;
g) said EZ-MOBILE AGENT creates a secret key using said SMS entered and other information specific to said user's mobile device;
h) said EZ-MOBILE AGENT sends said secret key to said EZ-registration server;
I) said EZ-registration server decrypts said received message and validates said PIN;
j) said EZ-registration server stores said device specific information and associates said user's cell number and an EZ-MOBILE AGENT Unique ID and sends registration confirmation to said EZ-MOBILE AGENT installed on said user's mobile device.

10. The remote confirmation and/or authentication and/or authorization service of claim 1 wherein, a third embodiment, user registration is comprised of the following steps:
a) said user sends SMS to said EZ-registration server with list of usernames/aliases with remote systems;
b) said EZ-registration server stores said information and associates said user's cell number;
c) said EZ-registration server sends said confirmation message and said cell number to said EZ-COMMUNICATION server;
d) said EZ-COMMUNICATION server sends said registration confirmation by SMS to said user's mobile device.

11. The remote confirmation and/or authentication and/or authorization service of claim 1 wherein, a first embodiment of a device verification/Confirmation is comprised of the following steps:
a) user makes request to Requester;
b) Requester validates user;
c) Requester sends a web service request for device verification to EZ-VERIFICATION server with said user's attributes and methodology to use;
d) if an identifier is an alias or medium is bio-metric, said EZ-VERIFICATION server checks for a match in an EZ-DB User database for a Unique ID of an installed agent on said user's mobile device or cell number;
e) a challenge process is initiated;
f) a result consists in accept, deny action or code being sent back to said Requester.

12. The remote confirmation and/or authentication and/or authentication service and/or authorization service of claim 1 wherein, in a second embodiment of a device verification/Confirmation is comprised of the following steps:
a) said user makes request to said Requester;
b) said Requester performs the first factor validation;
c) Requester sends username to said EZ-VERIFICATION agent using RADIUS to said EZ-VERIFICATION server or using web service/API;
d) said EZ-VERIFICATION agent or said Requester queries the corporate user information repository/database for an associated user attributes comprised, but not limited to phone number, email, third party attribute like google authorization;
e) said EZ-VERIFICATION agent or said Requester sends a web service request for device verification to said EZ-VERIFICATION server;
f) a challenge process is initiated.

13. The remote confirmation and/or authentication and/or authorization service of claim 1 wherein, in a third embodiment of a device verification/Confirmation is comprised of the following steps:
a) said user makes request for access to the Requester and Requester initiates a RADIUS request to said EZ-VERIFICATION agent;
b) If requested by said Requester said EZ-VERIFICATION agent performs a first factor validation by sending the identification information comprised of said user's username and password to a security server;
c) If said first factor is not requested or first factor verification was successful, said EZ-VERIFICATION agent verifies if an external party approval is required;
d) If an external party approval is required, said EZ-VERIFICATION agent performs a search in said predefined repository of said required attribute (comprised of LDAP, ODBC, DATABASE or any other structured repository) and sends said attribute value identifying the medium in a request to said EZ-VERIFICATION server for a challenge;
e) If said external party approval challenge process results in an approval or if said third party approval was not required, said EZ-VERIFICATION agent performs a search in said predefined repository (comprised of LDAP, ODBC, DATABASE or any other structured repository) for said user's attributes comprised of cell phone, email. telephone number or mobile application id like Google authorization);
f) said EZ-VERIFICATION agent sends attribute's value in a request comprised of a challenge type (message or action) and a medium to be used to said EZ-VERIFICATION server which then initiates said challenge process.

14. The remote confirmation and/or authentication and/or authorization service of claim 1 wherein, in a first embodiment of a challenge process is comprised of the following steps:
a) said EZ-VERIFICATION server receives a request for challenge with informations comprised of a technology/medium to be used, an attribute information, a message and a response type expected (being the result from the validation process or secret captured);
b) said EZ-VERIFICATION server sends the request to the EZ-COMMUNICATION server;
c) said EZ-COMMUNICATION server sends message to said user based on attribute information received that can be any of a mobile application, a mobile computing device, or email;
d) when medium is a phone call, said EZ-COMMUNICATION server calls the user's voice capable device and prompts said user with a message and captures a predefined key or unique secret pressed by said user;
e) If said medium is an encrypted WEBLINK SMS, said request is sent to said user's SMS capable device;
f) if said medium is SMS reply, said EZ-COMMUNICATION server sends a code to said user's SMS capable device and asks said user to reply using same code that is used to validate the code combined to the mobile device ID;
g) if said medium is biometric, said request is sent to said installed agent which will capture said user's heart rate and/or heat signature;
h) if said medium is an application, the request is sent using the application's communication predefined method;
I) said EZ-COMMUNICATION server returns any information captured to said EZ-VERIFICATION server;
j) said EZ-VERIFICATION server processes necessary validation and sends said response comprised of transaction completed, said received message, accept or reject to said EZ-VERIFICATION agent or said Requester;
k) said EZ-VERIFICATION agent evaluates any result received and sends a response to said Requester.

15. A remote confirmation and/or authentication service and/or authorization service used for confirmation of access identity, device ownership, and meetings using mobile devices for a system or an individual comprising the use of centralized or a decentralized attributes residing in at least one location; a flexible process to allow for a selection of a repository for every single attribute required in a remote access authentication process; verification can be performed through SMS replies by sending an SMS containing a secret code or an OTP to said user and requesting a reply with that same OTP that will be used to validate a combination of said OTP and said mobile computing SMS capable device's ID in possession of said user.

16. A remote confirmation and/or authentication service and/or authorization service used for confirmation of access identity, device ownership, and meetings using mobile devices for a system or an individual comprising the use of centralized or a decentralized attributes residing in at least one location; a flexible process to allow for a selection of a repository for every single attribute required in a remote access authentication process. within same authentication transaction initiated by said user, before said user gains remote access.

17. The remote confirmation and/or authentication service and/or authorization service of claim 1 wherein on a first attempt of a valid user to gain remote access, the instant invention recognizes the absence of a required attribute for the second factor challenge, and automates the transaction with the user to capture and add such attribute through SMS or Email; the attribute is then saved in the appropriate location.
